(19) United States
(12) Patent Application Publication
(10) Pub. No.: US 2007/0198385 A1
(43) Pub. Date: Aug. 23, 2007

(54) Process and method for establishing a commodity ceiling cap option targeted for retail consumption

(76) Inventors: Bradley McGill, Birmingham, AL (US); C. Todd McCormick, New York, NY (US); Daniel A. Sanabria, Birmingham, AL (US)

Correspondence Address: Daniel H. Golub, 1701 Market Street, Philadelphia, PA, 19103, US

(21) Appl. No.: 11/543,711

(22) Filed: Oct. 5, 2006

Related U.S. Application Data
(60) Provisional application No. 60/724,770, filed on Oct. 7, 2005.

(51) Int. Cl. G06Q 40/00

(52) U.S. Cl. 705/36 R

(57) ABSTRACT

A product and process that will enable retail consumers to hedge their exposure to volatile household commodities, such as gasoline and natural gas, by implementing optionality through channels where individuals already purchase those commodities. In turn, this aggregated retail optionality provides an attractive investment vehicle for institutions active in the energy and commodity markets. A commodity supplier such as gasoline retailer (or natural gas utility, credit card issuer, etc.) can sell caps on the cost of gasoline, etc, to its existing customers, in return for a periodic premium billed to the customer's captive credit card statement or utility bill. A dealer can package and securitize the risk in tranches.

### CROSS REFERENCE TO RELATED APPLICATIONS

This application claims priority to U.S. provisional application Ser. No. 60/724,770 filed on Oct. 7, 2005 entitled “Process and Method for Establishing a Commodity Ceiling Cap Option Targeted for Retail Consumption.”

### FIELD OF THE INVENTION

The present invention relates to a method for designing financial products to hedge against the price of commodities targeted for retail-consumption.

### BACKGROUND OF THE INVENTION

The vital importance of raw materials and energy resources in the economy of a country derives from its fundamental role as the building block of productivity. Thus, the degree of development of a country is mostly determined by its capacity to access the raw materials and energy to satisfy all their consumption needs, and the stability of the supply and prices of these resources. As a result, the everyday routine of an average consumer in an economy is directly affected by the fluctuation in the prices of commodities.

The global consumption of energy has increased dramatically over the past decades. With the experienced spectacular increase in the demand for natural resources, prices of energy products and commodities such as gasoline, natural gas and electricity have shown their largest jumps in history. The average consumer faces an inherent risk to his personal finances and well-being due to exposure to the price of consumable goods they use on a daily basis such as natural gas, gasoline or electricity.

In theory, an individual may use a derivate in the commodity markets as the basis to hedge or offset the risk in the volatile prices of a commodity affecting them. A financial derivative instrument (also referred to simply as a “derivative”) in the securities, trading, insurance, and economics communities includes a security or contract whose value depends on such factors as the value of an underlying security, index, asset or liability, or on a feature of such an underlying indicator such as interest rates. Financial futures on stock indices or options to buy and sell such futures contracts are highly popular exchange-traded financial derivatives. Derivatives are also traded on commodities, insurance events, and other events, such as the weather.

Traditionally, institutional investors have used derivatives to hedge and undertake economic exposure where there are inherent risks, such as risks of fluctuation in interest rates, foreign exchange rates, or equity markets. Coinciding with the experienced spectacular increases in gasoline prices of recent years, The Chicago Board of Options Exchange (CBOE) introduced the CFE Gas At The Pump^{SM} Futures (GAPP futures). GAPP futures are cash-settled futures contracts, settled on a monthly basis, designed to track the price of regular octane gasoline sold at retail gasoline outlets in the United States. Similar contracts based on the future price of gasoline trade on the New York Mercantile Exchange. Because of the high level of financial sophistication and capital required to operate in the derivative markets, the practical ability for the average consumer to hedge his risk exposure to the price of a commodity is limited and costly. As a result, individual investors have typically shown only a limited participation in derivative markets.

Various attempts have been made to create more individual, or retail, oriented derivative markets. One current example is HedgeStreet, a new exchange established to trade contracts with a notional value of only $10, positioned as a way for individuals to hedge risks. Activity on this exchange, as with retail participation in more-established exchanges, has been minimal. Various other start-up attempts have also been attempted to enable individuals to trade a range of other underlying instruments, such as residential real estate.

Another case that proves there is a high demand in the market for retail oriented products that enable a hedge against the rising price of commodities such as gasoline is represented by over 8,000 members in Minnesota's First Fuel Banks and companies of the like. First Fuel Banks offers individuals the opportunity to prepay any amount of gasoline offered at any of their six pumping locations. Through the use of a prepay card, First Fuel Banks customers can retrieve the repurchased gasoline at any time after they bought it.

Although programs like this allow individuals to deposit money at a posted price of a commodity and keep that price as market prices change, First Fuel Banks lack efficiency on their approach. Users of such programs need to make a relatively big investment to purchase the gasoline they intend to lock, and are limited to the amount they purchased at the locked price. Furthermore, under this scenario the consumers directly own the gas they purchase. In the event that an alternative fuel would cause gasoline prices to dramatically decline, costumers of these types of programs would potentially lose their entire investments.

With the tremendous increase in the demand for commodities such as gas, and the uncertainty and high volatility in the price of such goods, it is surprising that the market has not seen greater success in creating a method to allow the end consumer a more viable and successful venue on which to minimize the risk of rising prices of a particular commodity. This appears to be due to the absence of an effective method to facilitate the establishment of a hedging instrument that does not require the consumer to make big initial disbursements or access sophisticated derivatives markets. The general public's innate perception of derivatives and commodities as being risky, and the additional capital required to support these transactions, have precluded individuals from seeking out hedging opportunities.

If such a method were available to limit an individual's financial risk to a particular commodity with defined cost to the individual, with a minimal capital requirement, and in a method easily accessed by individual consumers through their routine shopping habits, and tailored to their consumption habits, it would too benefit those consumers who want to reduce their exposure to volatile prices of the consumable, while providing the social benefit of transferring risk from unsophisticated market participants to more-sophisticated investors skilled at pricing this risk.

### SUMMARY OF THE INVENTION

The present invention relates to a process for designing, creating and distributing products that will enable retail consumers to hedge their exposure to volatile household commodities, such as gasoline and natural gas, by implementing optionality through channels where individuals already purchase those commodities. In turn, this aggregated retail optionality will provide attractive investment vehicles for institutions active in the energy and commodity markets.

In one embodiment, a commodity supplier such as a gasoline retailer (or natural gas utility, credit card issuer, etc.) can sell caps on the cost of gasoline, etc, to its existing customers, in return for a fixed monthly premium billed to the customer's captive credit card statement or utility bill. The ownership of the commodity is not transferred to the customer until the cap is exercised. This novel process allows individuals an efficient way to lock in maximum costs for commodities used every day.

In addition, the seller of the options can sell the exposure to a dealer through a conduit. The dealer can then package and securitize the risk in tranches. Retail optionality is attractive to institutional investors due to the inefficient pricing.

The present invention provides a process and method for creating and distributing financial products to hedge against the price of commodities targeted for retail-consumption comprising the steps of: 1) selling, by a commodity retailer, the commodity to retail consumers; wherein the commodity has a market price that fluctuates over time; 2) establishing a price ceiling for the commodity, 3) at least one of: (i) marketing (e.g., by the commodity retailer) ceiling cap option contracts for the commodity to the retail consumers of the commodity, wherein the marketing is performed by including an advertisement for the ceiling cap option contracts in credit card statements sent to the retail consumers, or (ii) administering the ceiling cap option contracts with credit cards, prepaid cards or periodic statements reflecting purchases of the commodity from the commodity retailer (the credit cards, prepaid cards or periodic statements may optionally be branded with a trademark of the commodity retailer); 4) wherein each ceiling cap option contract guarantees to a retail consumer purchasing the contract that the consumer will be able to purchase at least a predefined quantity of the commodity from the commodity retailer for a price equal to the price ceiling if the market price of the commodity exceeds the price ceiling during an effective period of the contract; 5) selling the ceiling cap option contracts to retail consumers in exchange for contract premiums; and 6) transferring financial risks associated with the ceiling cap option contracts to institutional investors by securitizing cash flows associated with the ceiling cap option contracts into structured notes with varying tranches of inherent risks, and selling the structured notes to the institutional investors.

In some embodiments, the ceiling cap option contracts are put options, and may be issued by a producer of the commodity. The ceiling cap option contracts may also be sold to the retail consumers by the commodity retailer, and the structured notes may in turn be sold by the commodity retailer to the institutional investors. Alternatively, the ceiling cap option contracts may be issued by a financial services organization. In this alternative, the financial services organization may correspond to a credit card company that includes the advertisement for the ceiling cap option contracts in credit card statements that the credit card company sends to the retail consumers. Optionally, the credit card company services credit cards branded with a trademark of the commodity retailer, and the advertisement for the ceiling cap option contracts is included in statements associated with the branded credit cards.

The effective period of the ceiling cap option contract may correspond to a limited period of time or be perpetual. During the effective period, each ceiling cap option contract guarantees to a retail consumer purchasing the contract that the consumer will be able to purchase either a limited or unlimited amount (depending on the terms of the contract) of the commodity from the commodity retailer for a price equal to the price ceiling if the market price of the commodity exceeds the price ceiling during the effective period of the contract.

In some embodiments, a retail consumer purchasing the ceiling cap option contract uses a prepaid card to purchase the commodity from the commodity retailer during the effective period of the contract, and an account associated with the prepaid card is automatically debited in accordance with the lesser of the market price and the ceiling price following purchases of the commodity from the commodity retailer during the effective period of the contract. Alternatively, a retail consumer purchasing the ceiling cap option contract uses a credit card to purchase the commodity from the commodity retailer during the effective period of the contract, and an account associated with the credit card is automatically charged in accordance with the lesser of the market price and the ceiling price following purchases of the commodity from the commodity retailer during the effective period of the contract.

In the preferred embodiment of the method of the present invention premiums of the ceiling cap option contracts are fixed amounts charged on a periodic basis. Alternatively, the premiums of the ceiling cap option contracts can, in other embodiments, be variably charged on a per-purchase basis. For instance, the commodity retailer may offer variations in the price of the ceiling cap option contracts as an incentive for its customers to increase the quantities of their purchases of the particular commodity from the commodity retailer. As a result, a retail consumer purchasing a ceiling cap option contract will benefit from lower premiums during those periods in which the quantity of their purchases of the commodity from the commodity retailer exceeded a quantity defined by the commodity retailer, and consequently pay greater premiums on given periods where they did not reach a predetermined purchase level.

Under another embodiment, a buyer of the ceiling cap option contract may be able to alter the capped price at any given time during the duration of the contract, with a corresponding reassessment in the premiums. Under this scenario, a retail consumer purchasing the contract will better manage their protection from a commodity's costs spiraling out of control during times where they expect sharp increases or decreases in the market price of the commodity.

As mentioned above, each ceiling cap option contract guarantees to a retail consumer purchasing the contract that the consumer will be able to purchase at least a predefined quantity of the commodity from the commodity retailer for a price equal to the price ceiling if the market price of the commodity exceeds the price ceiling during an effective period of the contract. This guarantee can be implemented directly by allowing the retail consumer to simply pay the ceiling price at the point of purchase in instances where the market price exceeds the ceiling price. Alternatively, this guarantee can be implemented indirectly by having the retail consumer pay the market price at the point of purchase in instances where the market price exceeds the ceiling price, and then later reimbursing the retail consumer for the difference between the price paid by the consumer and the ceiling price. The reimbursing may be performed by a party holding an obligation under the ceiling cap option contract.

### BRIEF DESCRIPTION OF THE DRAWINGS

In the accompanying drawings:

FIG. 1 includes a schematic illustrating the method of the invention for creating and distributing financial products to hedge against the price of commodities targeted for retail-consumption.

### DETAILED DESCRIPTION OF THE INVENTION

In the context of the presented invention, the terms “price ceiling” or “price cap” or “cap” refer to a contractual limit on a price charged for a commodity having a market price that fluctuates. This limit price typically differs from the market price of the particular commodity at a given time.

For purposes of this application, “Ceiling Cap Option Contracts” refer to financial instruments, generally put options, which allow retail customers to effectively hedge against the risk in the price of a commodity by locking a ceiling price of the commodity through the purchase of these instruments. The Ceiling Cap Option Contracts guarantee to a retail consumer purchasing the contract that the consumer will be able to purchase at least a predefined quantity of the commodity from a commodity retailer for a price equal to the price ceiling if the market price of the commodity exceeds the price ceiling during an effective period of the contract

Additionally, a “commodity” in the context of the present invention refers to any raw material, utility or any consumer good such as gasoline, natural gas, electricity, water, etc., intended to be consumed (and not to be resold) by the end customers (retail consumers) purchasing the Ceiling Cap Option Contracts.

A “commodity retailer” under this application refers to any private or public business organization, that provides a commodity, such as water, electricity, transportation, or communication, to the public. A public or private utility is an example of a commodity retailer. Other examples of commodity retailers include retail marketers of gasoline.

Moreover, the terms “retail consumer”, “retail customer”, “end consumer” or “end customer” refer, in the context of the present application, to individuals who buy a particular commodity for their personal consumption, and not for the purposes of resale to another individual or organization.

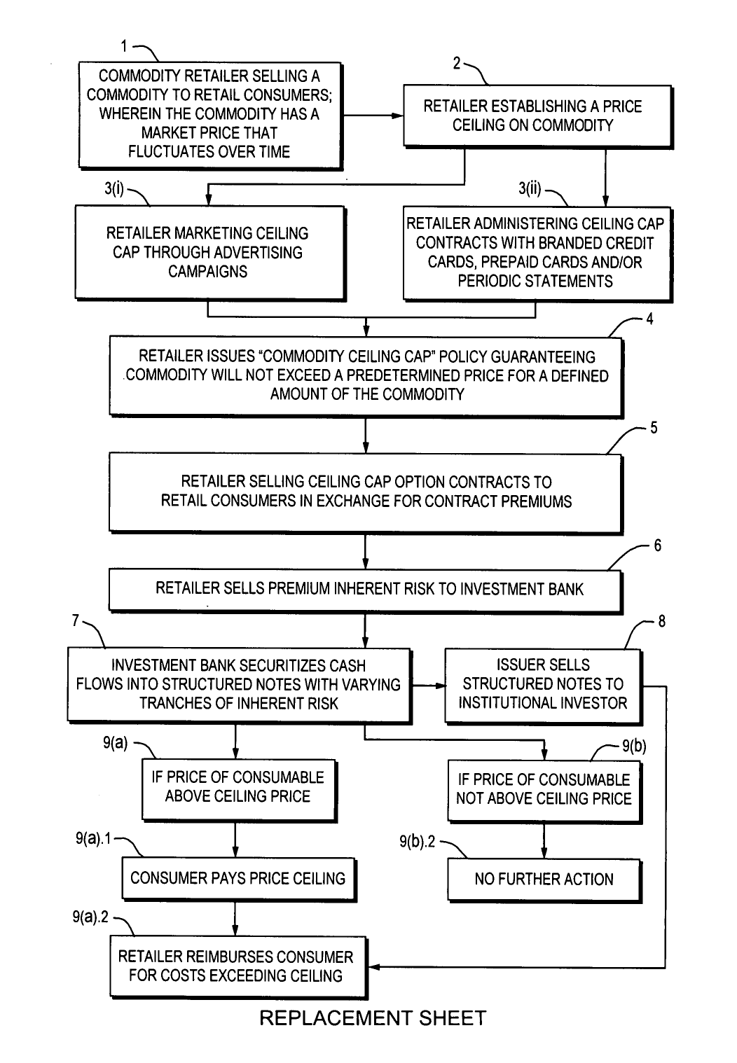

The novel process of the present invention would encompass the creation of a cost-efficient periodic premium vehicle that would serve retail consumers of a commodity as a hedge, for a defined period of time, against any increase over a stipulated price of such commodity. The present invention relates to the process for creating and distributing these customized derivative instruments to hedge against the risk of raising prices of a particular commodity. A preferred embodiment of this invention comprises a liquid secondary market in which this risk is transferred to willing buyers. By way of illustration, one possible implementation could involve ExxonMobil offering to allow its customers to purchase up to 100 gallons of gasoline per month for the next year at a maximum price of $2.75 per gallon, for a monthly fee billed to their proprietary credit card. ExxonMobil would then sell this exposure wholesale to an investment bank, which then packages the risk and premiums into tranches and sells them to institutional investors. The method of the preferred embodiment of the present invention is illustrated in the flow chart of FIG. 1.

Step 1 involves the commodity retailer selling a commodity to retail customers; wherein the commodity has a market price that fluctuates over time. In accordance with Step 2, the definition of optimal price ceilings for a given commodity is established by, for example, the company issuing the Ceiling Cap Option Contracts. In order to set a price ceiling this issuing company may receive input, as the flow of information from Step 6 shows, from a financial institution establishing a market price for the cap they will commit to securitize in a secondary market. In a preferred embodiment the issuing company is likely to be a commodity producer, distributor or retailer of significant size, one widely accessible by the retail customers and with multitude points of presence, or an entity or group within the supplier of the commodity, or an entity associated with a supplier of the commodity or group within the supplier of the commodity. Examples of the type companies that could issue the ceiling cap option described in the present invention may include a gasoline producer or retailer or a group associated or within a gasoline producer or retailer on a preferred embodiment, or gas, electric, water or other utility companies, or commodity suppliers in alternative embodiments.

Step 3 involves marketing and/or administration of the ceiling cap option contracts to retail customers through the creation of a distribution channel for this product. The supplier of the commodity could market this contract through existing branded credit cards that would track every purchase of the commodity at any of the issuer's locations. As an example, a gasoline company could charge a consumer a predetermined amount for the protection of this cap, with the consumer's authorization, in addition to the balance on the consumer's credit card, or a utility company could bill a recurring fee through monthly statements in the case of a utility bill. A commodity retailer may also market the ceiling cap option contracts for the commodity to the retail consumers of the commodity by including an advertisement for the ceiling cap option contracts in credit card statements sent to the retail consumers. The ceiling cap option contracts are preferably administered using credit cards, prepaid cards or prepaid statements branded with a trademark of the commodity retailer.

Step 4 involves a formal agreement between the issuing company and the retail consumer of the particular commodity. These contracts may either be of a broadly-accepted, universal design, if this design provides optimal functionality for consumers, or may be novel product designs and be designed specifically per each client. The immediate responsibilities of the issuing company include an obligation to guarantee that the consumer would not pay a price in excess of the predetermined price ceiling for a defined amount of the consumable, for a defined period of time. As an example of the preferred embodiment, a gasoline retailer could cap the consumer's retail cost $2.75 per gallon for a maximum of hundred (100) gallons per month. The retail price cap would be customized for different locations, reflecting current and local taxes, mark-ups, fuel formulations, transportation costs and other considerations. However, the net underlying wholesale cost of the commodity may be much more standardized, and allow aggregation of like caps at the wholesale level. The purchase of this ceiling cap option contract would provide a way for the average retail consumer to define his risk exposure to the price volatility of the particular commodity. The customer would know that as long they purchase the particular commodity from the issuing company, or selected locations under the terms of the agreement, they will not have to pay more than the price ceiling for the duration of the contract.

In turn, as Step 5 embraces, the retailer sells the commodity cap option contracts to its customers for which the consumers will pay a premium that will entitled them to pay the fixed maximum price for the commodity in the case the market price of the commodity were greater than the ceiling's rates. These premiums can either be charged on a per-purchase basis through a branded credit card or prepaid card, or through a monthly charge to the same credit card or prepaid card, or directly into the retail consumers' monthly statements.

The retail sale of thousands or millions of these Ceiling Cap Option Contracts by an issuing company would generate a substantial monthly flow of premium income, as well as contingent liability for the issuing company against rising prices of the particular commodity, which would otherwise be borne by those same institutions as the seller of the ceiling cap option contracts. Therefore, following Step 6, the issuing company could choose to sell both the income and liability streams from these ceiling cap option contracts to an investment bank, dealer or other financial institutions. Subsequent to the purchase of the premium liabilities, as Step 7 comprises, an investment bank buying these derivative contracts from the issuing company, would repackage the income and liability streams into securities that would trade over the counter (OTC) as different issuances of structured notes according to risk profile, price, exposure, etc., and sell them, according to Step 8, to institutional investors, hedge funds, pension funds or other financial institutions. Such structured notes could be defined by a number of unique characteristics for the institutional investor. Alternatively, the structured notes could be issued in tranches, with varying degrees of risk. The higher the income in a given tranche, the greater would be the direct exposure to the increase in commodity prices. Pools of these notes could also be rated by ratings agencies according to risk profile.

Steps 6 through 8 contemplate the creation of a liquid secondary market through which financial risks associated with the ceiling cap option contracts may be transferred from the issuer of the contracts to institutional investors by securitizing cash flows associated with the ceiling cap option contracts into structured notes with varying tranches of inherent risks. A flow of information regarding accurate market pricing would arise between the issuing company and the investment bank described in Step 7. Wholesale marketing of the ceiling cap option contracts can be performed by the issuing company, as described in Step 3(i), subsequent to the issuing company effectively and proactively establishing a marketable price ceiling according to the input on price data received by the investment bank. In some embodiments, the issuing company may create a conduit where the dealer or investment bank will commit by means of a formal agreement to buy a predetermined volume of income and liabilities associated with the premiums at the price cap marketed by the issuing company.

The aggregated effect of Steps 1-8, as described above, is a method which provides retail consumers an innovative locking option on the prices of a particular commodity. Step 9 as a whole describes the process by which settlement and payment of obligations under the ceiling cap option contracts may occur. Step 9a comprises the conditional event in which the market price of the commodity will surpass the ceiling price. In such case, following Step 9(a)1, the consumer could execute their right to only pay the price ceiling or, as Step 9(a)2 encompasses, the issuing company would reimburse the consumer for the costs exceeding the price ceiling, or would reimburse the retailer for cost beyond the cap at which they sell to the consumer. The investment bank, or financial institution described in Step 8 of the present invention that sells the commodity “puts” in the structured note, and collects a premium would be obligated to reimburse the issuing company. Thus the issuing company would in turn, according to Step 9(a)3 of the process, collect payouts of in-the-money value of options sold to the institutional investor. Alternatively, if the market price of the particular commodity does not move beyond the predetermined ceiling cap during the duration of the agreement, as described in Step 9b, the cap would expire worthless and no further action would follow Step 9(a)1.

Accordingly, the present invention provides a method for establishing a derivative instrument targeted to retail consumers that enables a hedge-against the risk of rising prices of a particular commodity, comprising the steps of: 1) selling, by a commodity retailer, the commodity to retail consumers; wherein the commodity has a market price that fluctuates over time; 2) establishing a price ceiling for the commodity 3) at least one of: (i) marketing ceiling cap option contracts for the commodity to the retail consumers of the commodity, wherein the marketing is performed by including an advertisement for the ceiling cap option contracts in credit card statements sent to the retail consumers, or (ii) administering the ceiling cap option contracts with credit cards, prepaid cards or periodic statements that reflect purchases of the commodity from the commodity retailer; 4) wherein each ceiling cap option contract guarantees to a retail consumer purchasing the contract that the consumer will be able to purchase at least a predefined quantity of the commodity from the commodity retailer for a price equal to the price ceiling if the market price of the commodity exceeds the price ceiling during an effective period of the contract; 5) selling the ceiling cap option contracts to retail consumers in exchange for contract premiums; and 6) transferring financial risks associated with the ceiling cap option contracts to institutional investors by securitizing cash flows associated with the ceiling cap option contracts into structured notes with varying tranches of inherent risks, and selling the structured notes to the institutional investors.

Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

We claim:

1. A method for creating and distributing financial products to hedge against the price of a commodity targeted for retail-consumption comprising the steps of:
(a) selling, by a commodity retailer, the commodity to retail consumers; wherein the commodity has a market price that fluctuates over time;
(b) establishing a price ceiling for the commodity;
(c) at least one of: (i) marketing ceiling cap option contracts for the commodity to the retail consumers of the commodity, wherein the marketing is performed by including an advertisement for the ceiling cap option contracts in credit card statements sent to the retail consumers, or (ii) administering the ceiling cap option contracts with credit cards, prepaid cards or periodic statements reflecting purchases of the commodity from the commodity retailer;
(d) wherein each ceiling cap option contract guarantees to a retail consumer purchasing the contract that the consumer will be able to purchase at least a predefined quantity of the commodity from the commodity retailer for a price equal to the price ceiling if the market price of the commodity exceeds the price ceiling during an effective period of the contract;
(e) selling the ceiling cap option contracts to retail consumers in exchange for contract premiums; and
(f) transferring financial risks associated with the ceiling cap option contracts to institutional investors by securitizing cash flows associated with the ceiling cap option contracts into structured notes with varying tranches of inherent risks, and selling the structured notes to the institutional investors.

2. The method of claim 1, wherein the ceiling cap option contracts are put options.

3. The method of claim 1, wherein the ceiling cap option contracts are issued by a producer of the commodity.

4. The method of claim 1, wherein the ceiling cap option contracts are sold to the retail consumers by the commodity retailer, and the structured notes are sold by the commodity retailer to the institutional investors in step (f).

5. The method of claim 1, wherein the ceiling cap option contracts are issued by a financial services organization.

6. The method of claim 5, wherein the financial services organization is a credit card company that includes the advertisement for the ceiling cap option contracts in credit card statements that the credit card company sends to the retail consumers.

7. The method of claim 6, wherein the credit card company services credit cards branded with a trademark of the commodity retailer, and the advertisement for the ceiling cap option contracts is included in statements associated with the branded credit cards.

8. The method of claim 1, wherein step (c) comprises:
(c) at least one of: (i) marketing, by the commodity retailer, ceiling cap option contracts for the commodity to the retail consumers of the commodity, wherein the marketing is performed by including an advertisement for the ceiling cap option contracts in credit card statements sent to the retail consumers, or (ii) administering the ceiling cap option contracts with credit cards, prepaid cards or periodic statements branded with a trademark of the commodity retailer.

9. The method of claim 1, wherein the effective period of the ceiling cap option contract is a limited period of time.

10. The method of claim 1, wherein the effective period of the ceiling cap option contract is perpetual.

11. The method of claim 1, wherein each ceiling cap option contract guarantees to a retail consumer purchasing the contract that the consumer will be able to purchase a limited amount of the commodity from the commodity retailer for a price equal to the price ceiling if the market price of the commodity exceeds the price ceiling during the effective period of the contract.

12. The method of claim 1, wherein each ceiling cap option contract guarantees to a retail consumer purchasing the contract that the consumer will be able to purchase an unlimited amount of the commodity from the commodity retailer for a price equal to the price ceiling if the market price of the commodity exceeds the price ceiling during the effective period of the contract.

13. The method of claim 1, wherein a retail consumer purchasing the ceiling cap option contract uses a prepaid card to purchase the commodity from the commodity retailer during the effective period of the contract, and an account associated with the prepaid card is automatically debited in accordance with the lesser of the market price and the ceiling price following purchases of the commodity from the commodity retailer during the effective period of the contract.

14. The method of claim 1, wherein a retail consumer purchasing the ceiling cap option contract uses a credit card to purchase the commodity from the commodity retailer during the effective period of the contract, and an account associated with the credit card is automatically charged in accordance with the lesser of the market price and the ceiling price following purchases of the commodity from the commodity retailer during the effective period of the contract.

15. The method of claim 1, wherein the premium of the ceiling cap option contract for a given retail customer varies in accordance with a quantity of the commodity purchased by the given retail customer from the commodity retailer.

16. The method of claim 1, wherein the premiums of the ceiling cap option contracts are fixed amounts charged on a periodic basis.

17. The method of claim 1, wherein a retail consumer purchasing the ceiling cap option contract buys some quantity of the commodity from the commodity retailer by paying the commodity retailer the market price during a time when the market price of the commodity is over the ceiling price, and the retail consumer is later reimbursed by a party holding an obligation under the ceiling cap option contract for the difference between the price paid by the consumer and the ceiling price.

18. The method of claim 1, wherein a retail consumer buying a ceiling cap option contract alters the ceiling price during the effective period of the contract by paying a further premium during the effective period, wherein the further premium is in excess of a premium charged for an initial sale of the ceiling cap option contract to the retail consumer.
